(19) United States
(12) Patent Application Publication
(10) Pub. No.: US 2004/0059710 A1
(43) Pub. Date: Mar. 25, 2004

(54) Method and system for processing export information

(76) Inventors: Yun-Chi Lee, Taipei (TW); Wen-Yi Chang, Taipei (TW); Yueh-Chiu Lin, Taipei (TW)

Correspondence Address: BIRCH STEWART KOLASCH & BIRCH, PO BOX 747, FALLS CHURCH, VA, 22040-0747, US

(21) Appl. No.: 10/401,793

(22) Filed: Mar. 31, 2003

(30) Foreign Application Priority Data
Jul. 30, 2002 (TW) 091116960

(51) Int. Cl. G06F 7/00

(52) U.S. Cl. 707/1

(57) ABSTRACT

A method and a system for processing export information are provided by which a user at a computer device is linked to the export information processing system via a network connection to perform instant and convenient export information processing. A goods database for storing goods related information is established in the export information processing system to allow users to enter goods related information for soon-to-be-exported goods. A display of available goods from the goods database is generated on the computer device according to inquiry conditions inputted from the user to the export information processing system to allow the user to select export goods. Then, export files are created for the selected export goods to provide reference for inquiry of export information.

### FIELD OF THE INVENTION

The present invention relates to inquiry mechanisms, and more particularly, to a method and a system for instant online retrieval of export information.

### BACKGROUND OF THE INVENTION

In the recent years, the up rise of the global economy has lead to an increase in the daily quota of purchase orders from exporters. In the conventional method, a significant amount of clerical staff is required to handle the amount of paperwork involved for updating the export information. As a result, using human power to process this information requires a lot of time. Although most large companies demand the daily purchase orders to be processed by the end of the day, clients and downstream companies still cannot get immediate access to the present status of the delivery to schedule the subsequent logistics.

Therefore the immediate problem to be solved is how to provide a method and system for processing export information that can allow export manufacturers to gain instant access to the present status of the delivery while reducing the amount of paperwork, faxes, and communications in the export process.

### SUMMARY OF THE INVENTION

A primary objective of the present invention is to provide a method and system for processing export information which allows exporters to use an online computer system to instantly inquire the receipt of the most recent purchase orders for scheduling subsequent logistics.

According to the above and other objectives, the present invention provides a method for processing export information. The method for processing export information establishes a network connection between an end user of a computer device to the export information processing system through an online connection. A goods database for storing the related information of the goods is first established in the export information processing system to allow users to process the export information. The export information processing method comprises: inputting the related information of the goods in the export process through a computer device by a user; generating a display on the computer device of the available goods in the goods database that have information that matches the inputted goods information in the export information processing system and allowing the user to select the desired goods; and creating export files of the selected goods by the export information processing system to provide reference for inquiry and report of the export information.

The user inputs the related information of the exportation such as sales unit, estimated time of delivery, and the like through a computer device. The export information processing system finds the goods information in the goods database that matches the related information of the inputted data. The goods information is then assigned with an invoice number, a payment order number, and a transportation identification number which are used to generate the export file of the various goods after the user has selected the desired goods information. Furthermore, the export information processing system allows the user to print out the invoice and package details of the export goods according to the export files.

The present invention provides an export information processing system that executes the abovementioned method. The export information processing system comprises: a goods database for storing the related information of the goods; an inquiry module for receiving the inquiry fields from the user in the computer device, wherein the inquiry module generates a display on the computer device of the available goods from the goods database that have information that matches the inputted goods information by the export information processing system and allowing the user to select the desired goods; a file create module for creating export files according to the selected goods received by the inquiry module; and an export file database for storing the export files created by the file create module.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram of the export information processing system according to one embodiment of the present invention;

FIGS. 2(A) to 2(J) are schematic web page displays according to the operation process of the export information processing system of the present invention; and

FIG. 3 is a flow diagram according to the method for processing export information of the present invention.

### DETAILED DESCRIPTION OF THE PREFERRED EMBODIMENTS

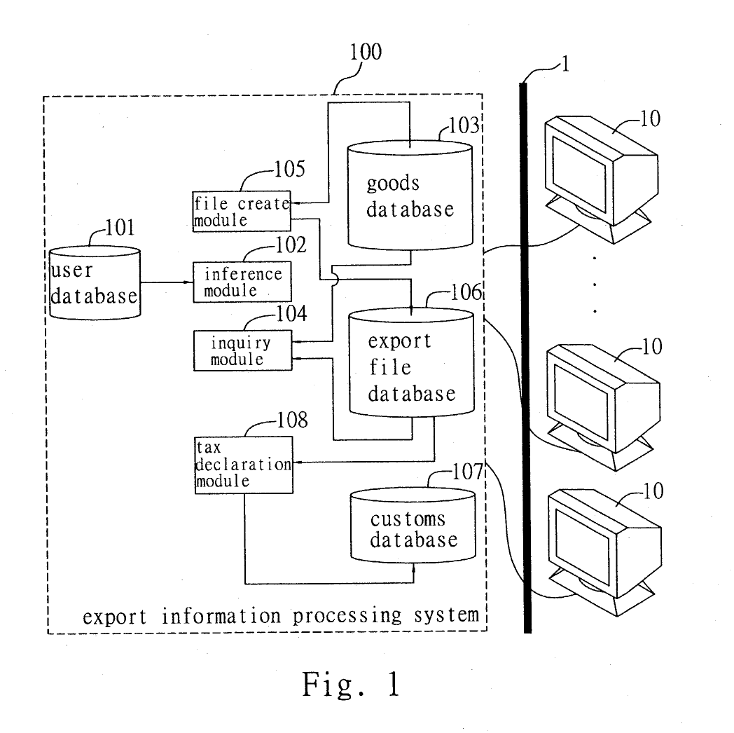

Please refer to FIG. 1, it illustrates a block diagram of the export information processing system according to one embodiment of the present invention. As shown in FIG. 1, the export information processing system 100 (enclosed by the dotted lines) is disposed inside a web server (not shown) for users to enter the export information processing system 100 through an online connection 1 such as an internet by a computer device 10 (for example a personal digital assistant, a desktop computer, a laptop computer, a palmtop computer, or a mobile phone). The export information processing system 100 comprises at least a user database 101, an inference module 102, a goods database 103, an inquiry module 104, a file create module 105, an export file database 106, a customs database 107, and a tax declaration module 108. It is to be noted that the export information processing system 100 can possess other functional modules and is not limited to what is descried in this embodiment, only what is relevant to the present invention is disclosed.

The user database 101 stores the user details required for entering the export information processing system 100, wherein the users comprise exporters, the receive companies that transact with the exporters, export representative, monitor units for monitoring goods logistics (such as export representative or customs department), and servicemen for maintaining normal operation of the system. The present invention is mainly used in processing export goods so the categories of the goods are classified as export goods. The inference module 102 is disposed in the export information processing system 100 for displaying an identification display to allow users to enter identification information such as login and password when the user logins or sends a special request using the computer device 10. The inference module 102 limits the level of authority of the users by matching the inputted data to that in the user database 101 to increase the level of security of the export information processing system 100. Due to the procedures and process for users to login to a web server are considered common and well-known operations, the details of the process and structure are therefore not described.

The goods database 103 stores the related information of various goods of the exporters, wherein the related information comprises origin of manufacture, goods model, goods weight, unit price, the part (raw material) list, and the estimated delivery location and time. This related goods information is usually first created and stored in the goods database 103 by the exporters through the computer device 10 to provide downstream companies with reference information for processing the exportation.

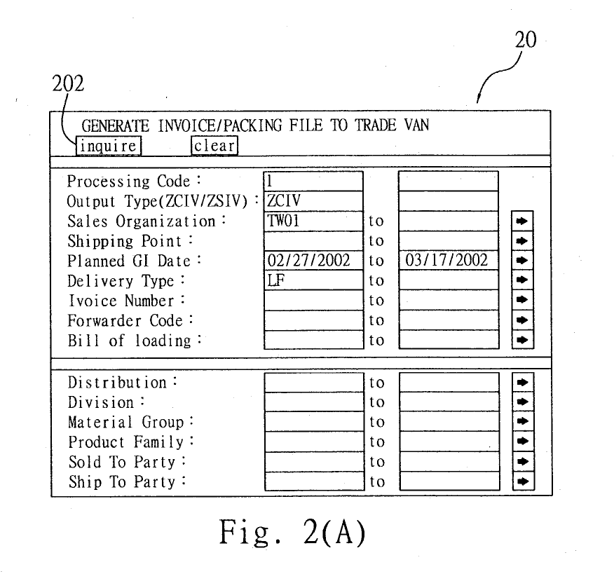

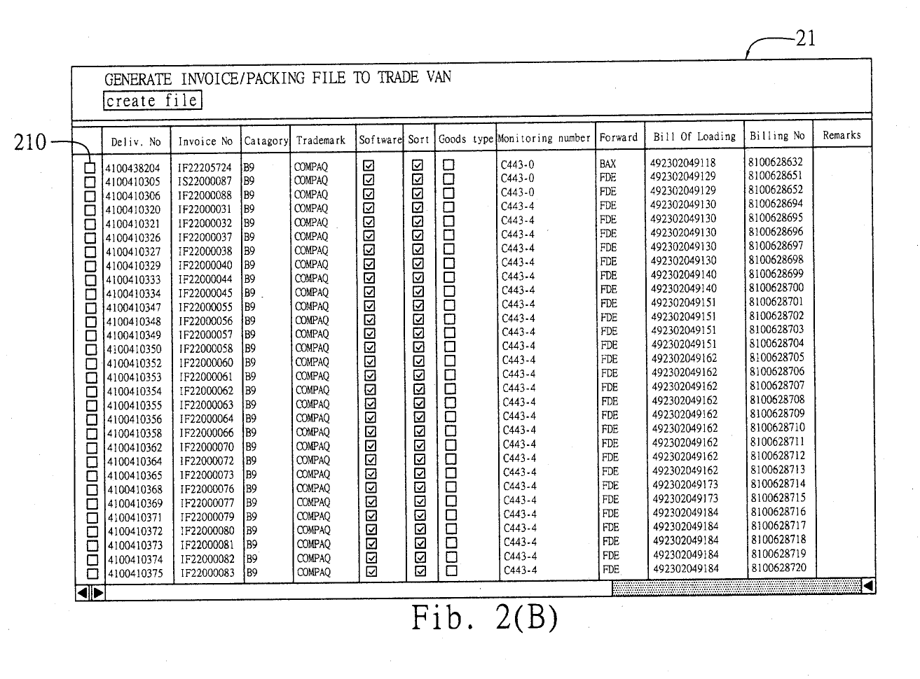

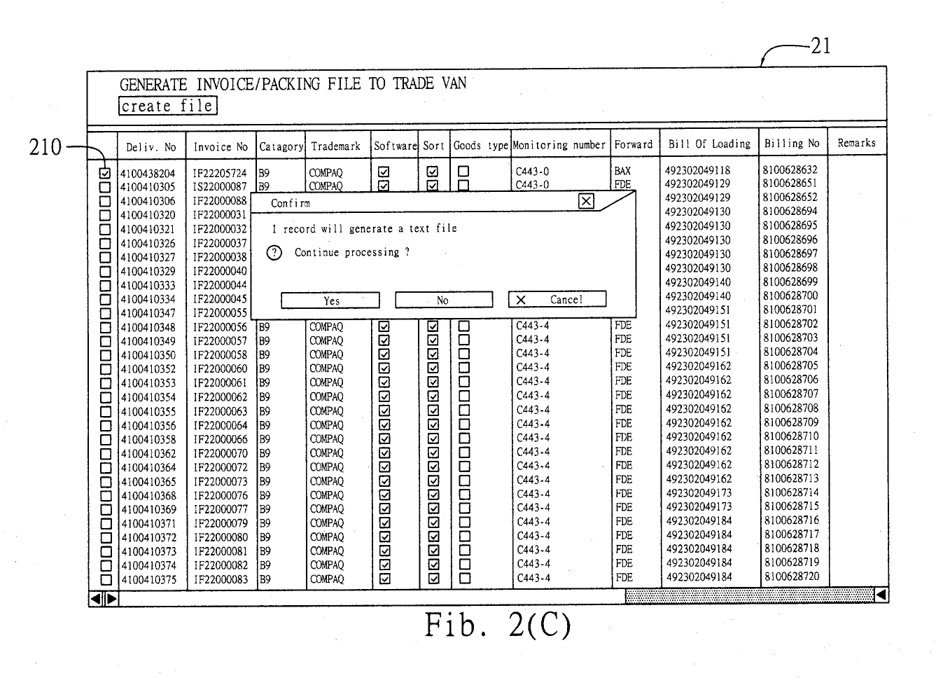

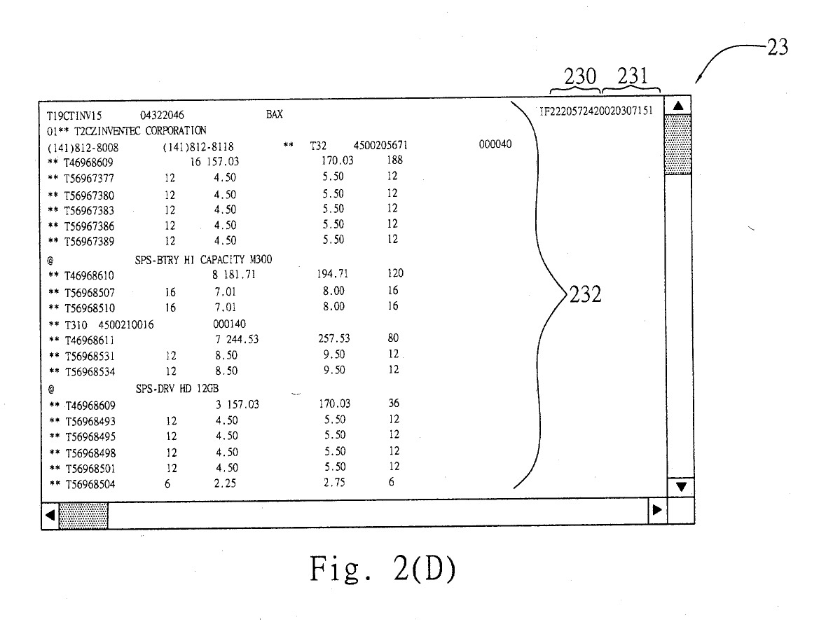

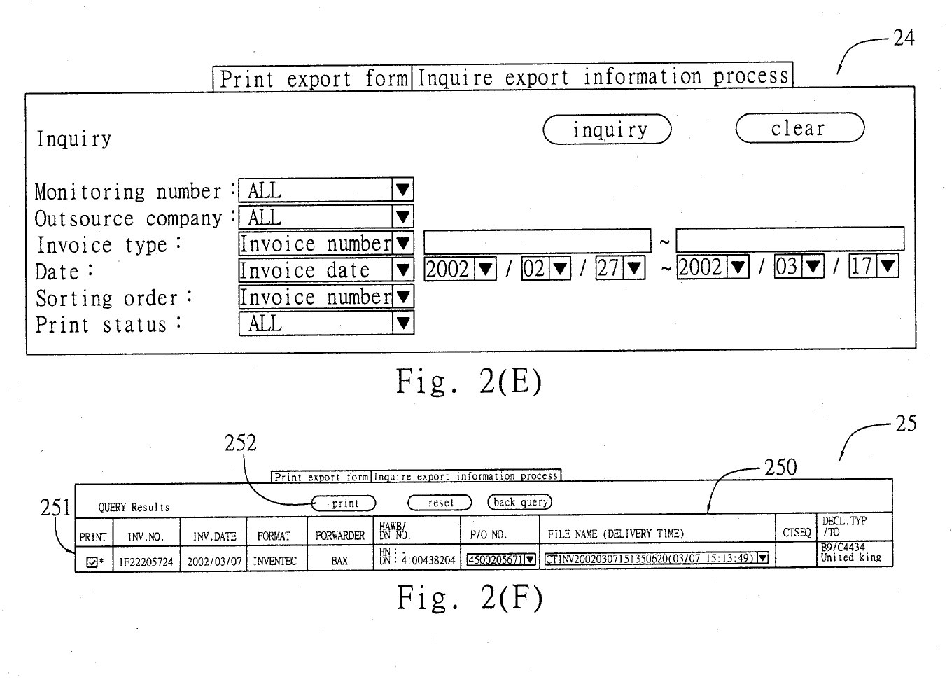

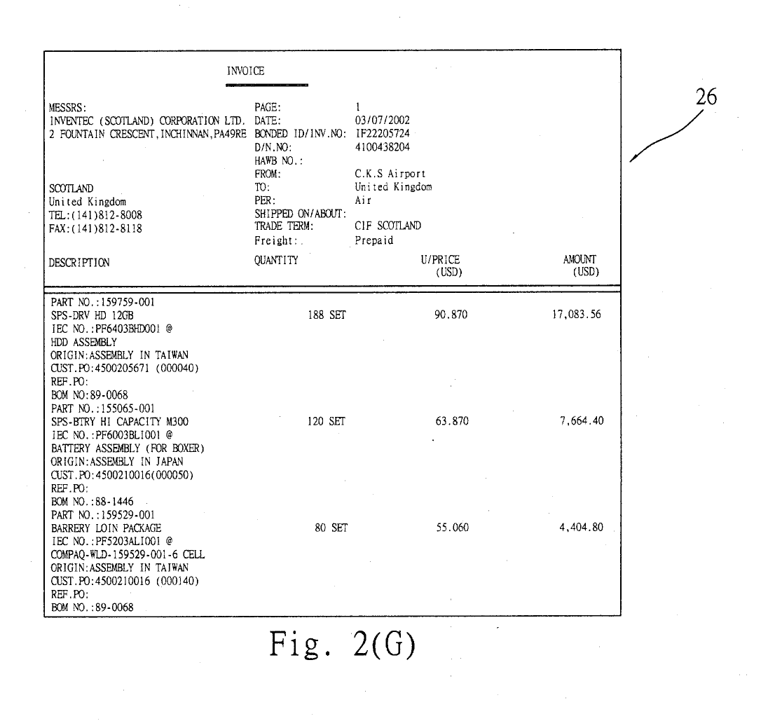

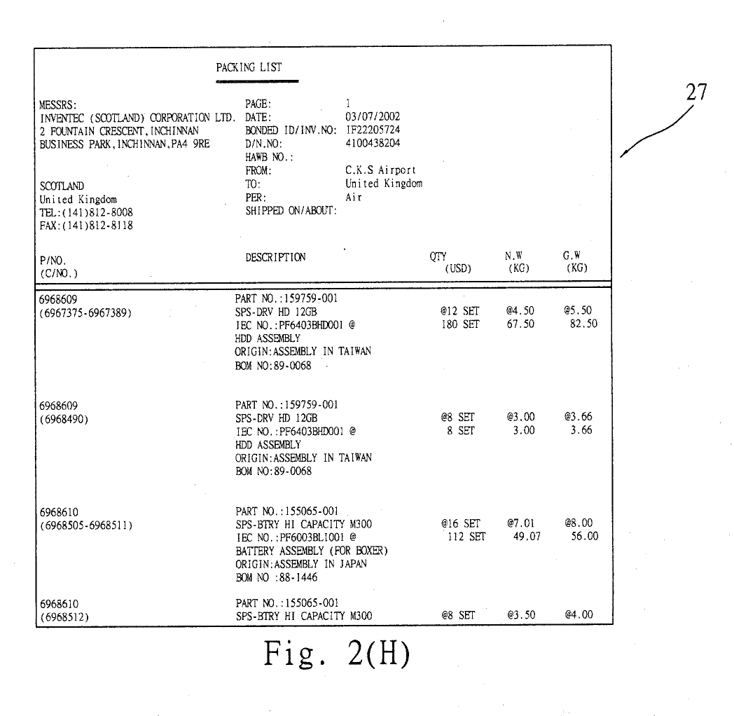

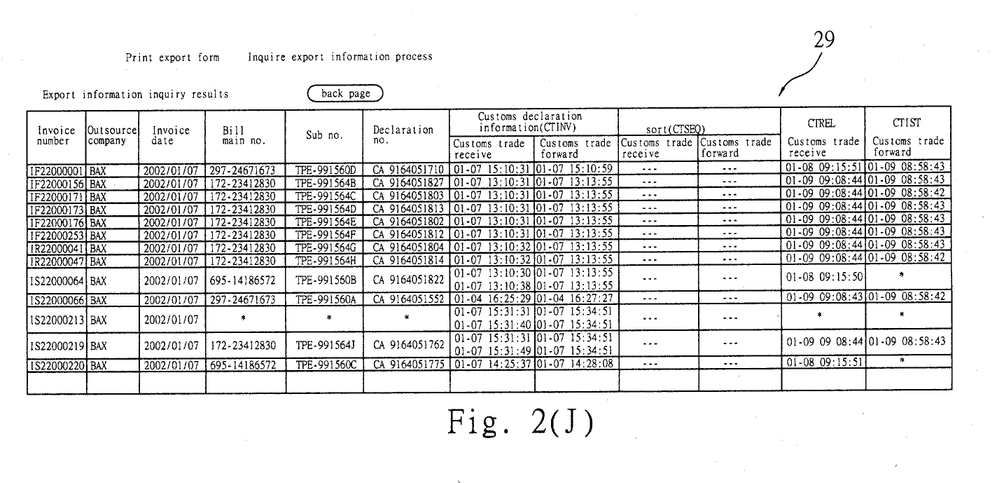

The inquiry module 104 is disposed in the export information processing system 10 for receiving the inquiry fields. The inquiry module 104 at least provides a goods delivery inquiry display 20 in FIG. 2(A) and an export inquiry display 24 and an export information display 28 in FIGS. 2(E) and 2(I) for users at the computer device 10 to enter the inquiry fields. The inquiry module 104 executes corresponding actions according to the information inputted by the user. The file create module 105 creates and stores files in the file database 106 according to the specified files of the soon-to-be-export goods to allow the inquiry module 104 to inform the exporter, the receive company (such as one for the exporter), the freight company, and the like of the status of the exportation. (The following describes the details of the inquiry and file create processes.)

The tax declaration module 108 is disposed in the export information processing system 100 and receives the declaration request sent by the export representative through the computer device 10 and displays a declaration display (not shown) on the computer device 10 to allow the export representative to perform the declaration process. The source of the declaration display is based on the content of the export files (not shown) in the export file database 106 to allow the export representative to compare and verify the export goods.

After the export representative has finished the comparison and verification in the declaration display provided by the tax declaration module 108, it will provide a declaration form (not shown) to the export representative through the computer device 10. The export representative inputs the related goods information of the successfully exported goods through the computer device 10 and the tax declaration module 108 stores the inputted data in the customs database 107. Therefore the exporters can enter the export information processing system 100 of the present invention through a computer device 10 and an online connection 1 to initiate the tax declaration module 108 to extract the declaration information of various goods from the declaration database 107 for performing monthly statements and export related operations. Please refer to FIG. 2(A), it shows a goods delivery inquiry display 20 which is an inquiry input display transmitted from the export information processing system 100 to the user to allow the exporter to input any inquiry fields in the inquiry display before the exportation (please note the following clarification, the computer device 10 needs to be equipped with a browser such as Microsoft® Internet Explorer® or Netscape® Navigator® in order to connect to the export information processing system 100 of the present invention to obtain the display transmitted by the export information processing system 100). The user can enter “TW01” (an identification reference representing the first factory in Taiwan) in the sales location field 200 of the goods delivery inquiry display 20 and “02/27/2002 to 03/17/2002” in the estimated delivery time field 201 and the required information in other inquiry fields. Afterwards the user enters the inquiry command key 202 to initiate the inquiry module 204 to extract the matching goods information in the goods database 103 according to the inputted inquiry fields by the user, as illustrated in FIG. 2(B).

FIG. 2(B) shows a goods delivery display 21 for users to select the goods to be exported by crossing off the check box 210, as illustrated in FIG. 2(C).

FIG. 2(C) is a goods delivery confirmation display 22. After the user has finished crossing off the check boxes 210 and has entered the file create key 221, the file create module 105 will transmit a confirmation dialog 222 to verify if the user wishes to create the files. If yes, the file create module 105 will create the export files according to the goods information selected by the user. The content of the export file is shown in FIG. 2(D).

FIG. 2(D) is a goods description content 23 of an export file. The content is based on the goods information stored in the goods database 103. In the goods description content 23, the reference numeral 230 indicates the invoice number of the export goods, the reference numeral 231 indicates the file name of the export file, the reference numeral 232 indicates the details of the export goods such as the weight, value, goods model number, goods name and the like. Furthermore the save format of the export files can be normal plain text in which the information of different fields is distinguished by using blank data to allow the export information processing system 100 to differentiate.

FIGS. 2(A) to 2(D) show the exportation procedures of an exporter. After finishing the file create step of the export goods, the following FIGS. 2(E) to (J) provide not only the exporter but also the receive company and the export control unit to perform inquiry. Firstly, please refer to FIG. 2(E), it shows an export inquiry display 24 which is generated by the export information processing system 100 through the online connection 1 to provide the user (such as exporter, receive company, or export control unit) at the computer device 10 to input the inquiry fields to locate the export goods information and furthermore to print them out. FIG. 2(F) shows an export goods print-out display 25, wherein the batch record 251 of the form 250 comes from the export files shown in FIG. 2(D). The invoice number and the file name of the batch record 251 is shown as “IF22205724” and “CTINV20020307151350620” respectively. Wherein the file name at least comprising year, month, day, hour, minute, second, and the like is named after the time at which the file is created by the file create module 105 when the exporter submits a file create request (as shown in FIG. 2(C)). After the user has entered the print command key 252, the details of the invoice list 26 in FIG. 2(G) and the packing list 27 in FIG. 2(H) are printed out. The present invention provides exporter, receive companies, and export control units with an instant and time-saving export information inquiry and report processing method.

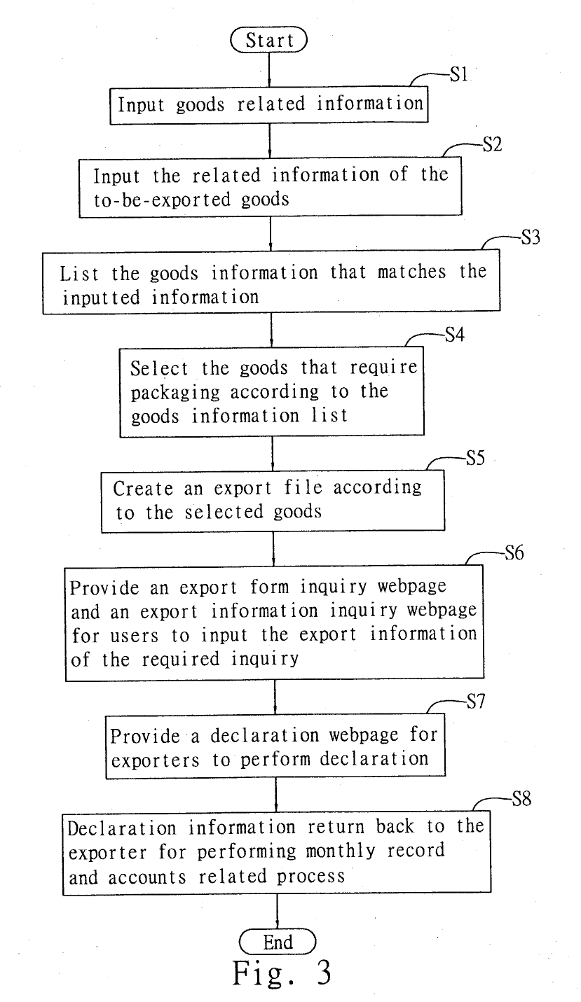

Following, please refer to FIG. 2(I), it shows the export information display 28 which is similar to FIG. 2(E) for providing users to input the required inquiry fields of the required export goods information. FIG. 2(J) shows a results display 29 of the export information inquiry by which users can instantly and easily locate the processing status of the export information from the results display 29. Please refer to FIG. 3, it shows a flow chart of the process of the export information processing system 100. Please refer to FIGS. 1 and 2 simultaneously for the explanation of the export information processing method.

First perform step S1 where the exporters create the related goods information such as the origin of manufacture, the model number, the weight, the unit price, the part (raw material) list, the estimated delivery location and time, and the like and transmit this information to the export information processing system 100 for storage in the goods database 103.

Following proceed to step S2, the computer device 10 of the exporter connects to the export information processing system 100 of the present invention through Internet to submit a goods delivery request. The inquiry module 104 of the export information processing system 100 generates a goods delivery display 20 on the computer device 10. The exporter then inputs the related goods information of the soon-to-be-exported goods as the inquiry fields, as shown in FIG. 2(A).

Afterwards proceed to step S3, the inquiry module 104 locates the goods information in the goods database 103 that matches the inputted related goods information and displays the results on the computer device 10, as shown in FIG. 2(B).

Following in step S4, the exporter will select the export goods according to the list generated by the inquiry module 104, as shown in FIG. 2(C).

Next in step S5, the file create module 105 of the export information processing system 100 creates the export files according to the selected goods by the exporter and stores them in the export file database 106, as shown in FIG. 2(D).

Then in step S6, if the exporter, the receive company, or the export control unit (such as export representative or customs unit) wishes to inquire export information, they can use their computer device 10 to connect to the export information processing system 100 via the online connection 1. The export information processing system 100 provides an export declaration and an export information inquiry display (24, 28) on the computer device 10, as shown in FIGS. 2(E) and 2(I) to allow users to input the required inquiry fields. The export information processing system 100 locates the goods information that matches the inquiry and displays on the computer device 10, as shown in FIGS. 2(F) and 2(J). Furthermore the user can selectively print out more detailed invoice list or packing list of the export goods, as shown in FIGS. 2(G) and 2(H).

Following in step S7, if the export representatives wish to perform the declaration process on the export goods, they can initiate the tax declaration module 108 through the computer device 10 and the online connection 1 to generate a declaration display (not shown) on the computer device 10. The export representative compares and verifies the export goods according to the declaration display. After the comparison and verification, the declaration database is created.

Next in step S8, after the export representative finishes the export goods declaration process, the tax declaration module 108 stores the created declaration information in the declaration database 107. Therefore the exporters can use the export information processing system 100 through the computer device 10 and the online connection 1 to initiate the tax declaration module 108 to obtain the declaration information of export goods from the declaration database 107 for up keeping monthly statements and export related reports.

The aforementioned only exemplifies the preferred embodiment of the present invention but does not impose any restriction on the scope of the technology involved in the present invention, for example the web page displays of the export information processing method are not limited to what is shown in FIGS. 2(A) to 2(J) and can comprise any other export information depending on the embodiment. Furthermore when the user requests to create a file in the export information processing system 100, the export information processing system 100 will verify the identify of the user to ensure the security of the online process.

The present invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An export information processing method for allowing a user at a computer device to be connected with an export information processing system via an online connection system to perform export information processing, with a product database being established in the export information processing system for storing product related information, the method comprising the steps of:
inputting product related information for products intended to be exported via the user through the computer device;
having the export information processing system search corresponding products from the product database according to the inputted product related information and display the searched products on the computer device for allowing the user to select export products; and
having the export information processing system create export files corresponding to the selected export products and store the export files as reference for users' inquiry.

2. The method of claim 1, wherein the online connection system is Internet.

3. The method of claim 1, wherein the computer device is connected to the export information processing system via an Internet browser.

4. The method of claim 1, wherein the product related information inputted by the user comprises at least a sales volume and an estimated time of delivery.

5. The method of claim 1, wherein content of the export files comprises an invoice list and a packing list of the export products.

6. The method of claim 1, wherein the users who have access to inquire the export files include exporters, receiving companies that deal with the exporters, transporters who deliver the export products to the receiving companies, product logistics monitoring personnel, and servicemen who maintain normal operation of the export information processing system.

7. The method of claim 1, wherein after the step of creating the export files, the export information processing system generates and displays a declaration display on the computer device corresponding to the export files to allow the users to compare and verify the export products according to the declaration display and to allow the export products to pass the customs through the use of the export information processing system.

8. The method of claim 7, wherein after the export products pass the customs, the export information processing system generates customs information for the verified export products and stores the customs information in a customs database as reference for monthly statements and export inventory.

9. An export information processing system for allowing a user at a computer device to be connected with an export information processing system via an online connection system to perform export information processing, the export information processing system comprising:
a product database for storing product related information;
an inquiry module for receiving inquiry conditions of product related information inputted by the user at the computer device, and for searching corresponding products from the product database according to the inputted inquiry conditions and displaying the searched products on the computer device for allowing the user to select export products;
a file create module for creating export files corresponding to the selected export products from the inquiry module; and
an export file database for storing the export files created by the file create module.

10. The system of claim 9, wherein the online connection system is Internet.

11. The system of claim 9, wherein the computer device is connected to the export information processing system via an Internet browser.

12. The system of claim 9, wherein the inquiry conditions of product related information inputted by the user comprise at least a sales volume and an estimated time of delivery.

13. The system of claim 9, wherein content of the export files comprises an invoice list and a packing list of the export products.

14. The system of claim 9, wherein users who have access to inquire the export files include exporters, receiving companies that deal with the exporters, transporters who deliver the export products to the receiving companies, product logistics monitoring personnel, and servicemen who maintain normal operation of the export information processing system.

15. The system of claim 9, further comprising a tax declaration module and a customs database, wherein the tax declaration module generates a declaration display on the computer device according to the export files stored in the export file database to allow the user to compare and verify the export products according to the declaration display, and the tax declaration module generates customs information for the verified export products and stores the customs information in the customs database as reference for monthly statements and export inventory.
